(19) United States
(12) Patent Application Publication
(10) Pub. No.: US 2012/0183916 A1
(43) Pub. Date: Jul. 19, 2012

(54) ELASTIC RING MOUNTING PISTOL

(76) Inventor: Peter Steven, (US)

(21) Appl. No.: 12/998,592

(22) PCT Filed: Jul. 22, 2009
(86) PCT No.: PCT/DE09/00983

§ 371 Date: Mar. 9, 2012

(51) Int. Cl. A61C 7/30

(52) U.S. Cl. 433/3

(57) ABSTRACT

The invention relates to a ring installation pistol (1), which is used to automatically install orthodontic rings made of elastic material, which are molded onto a strip (7). By pulling the trigger (2), which is installed in a pistol-shaped housing (3), the working piston (4) is pressed forward. There, the wire fork tips (5), which have been moved toward each other, reach into one of the molded-on rings (6) and remove said ring from the strip of the ring by pulling the ring. At the same time, the magazine (8) moves to the side. The ring separated in such a way is then expanded by the spreading of the forks and pushed off onto a metal lock. When the trigger is returned, a gear (10) in the magazine is actuated by means of a transport lever (9), which gear moves the strip by means of a transport wheel (11) in such a way that the next ring on the strip can be grabbed in the following operation.

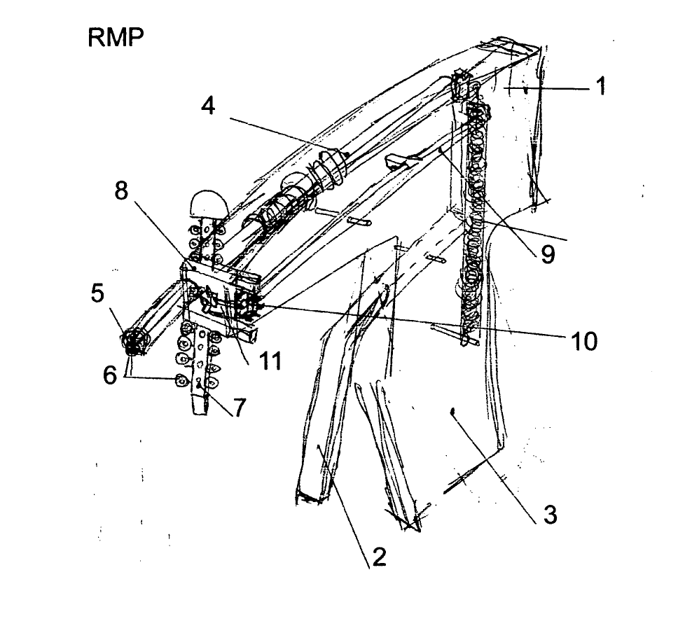

### DESCRIPTION AND FUNCTION

The ringmountingpistol (1) is used for automatical mounting of elastic rings, which are fixed at a stripe. The elastic rings are needed for the fixation of an archwire in brackets, used by a fixed orthodontic dental appliance. Firing the withdrawal lever (2), mounted in the pistol case (3), the plunger is pushed forward. There the peaks of forks made of wire (5) spear one of the rings and separate it from the stripe. The magazine (8) is laterally forced to one side. The separated ring can be spreaded by the forks and slipped of on the bracket. This spreading is already known and does not belong to the patent. The patent refers to the automatically loading pistol with its lateral moveable magazine and the rings and stripes of elastic material. Going back, the withdrawal lever (2) moves a toothed wheel (10) in the magazine (11) by a transporting lever (9), which advances the stripe, moving linear in one direction, so that the next ring comes into the position to be fired off.

### SUMMARY

The patent application claims the automatically working ringmountingpistol, characterized by loading automatically elastic rings of a lateral moveable magazine, synchronized by the withdrawal lever.

So a single-handed use of the pistol is possible.

The patent application claims also the especially needed elastic ringstripes fixing the rings that are processed. The strip is characterized by special wholes, defining the steps. The strip himself is the carrier of the rings.

1) The claim is pretended for the automatically working Ringmountingpistol, by loading the elastic rings through a lateral moveable magazine, triggered by an withdrawal lever (2). The lateral moveable magazine slides always to one side in one period of the working phase. The movement of the ringstripe is done by a special toothwheel, which is turned step by step through the withdrawal lever. One step corresponds to linear movement from one ring to the next. By the pistol a single-handed mounting of the rings is possible.

2) Another claim is pretended for the special stripes (7), carrying the needed rings. The stripe is characterized through special wholes or notches, defining the movement from ring to ring.
